(19) United States
(12) Patent Application Publication
(10) Pub. No.: US 2008/0217415 A1
(43) Pub. Date: Sep. 11, 2008

(54) Stored value card package with a combined UPC and activation magnetic stripe

(76) Inventor: Melanie Royer, Victoria, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 12/004,807

(22) Filed: Dec. 21, 2007

Related U.S. Application Data
(60) Provisional application No. 60/876,683, filed on Dec. 21, 2006.

(51) Int. Cl. G06K 19/06

(52) U.S. Cl. 235/493

(57) ABSTRACT

An integrated breakaway package with one or more stored value card is presented in which a card magnetic stripe is found on each stored value card and a package magnetic stripe is found on an end portion of the breakaway packaging. Each card magnetic stripe identifies an account associated with the stored value card. The package magnetic stripe contains both a Universal Product Code associated with the package as well as account activation information. The Universal Product Code identifies the package and card at a point of sale device to allow completion of a sales transaction. The activation information identifies all of the accounts associated with the stored value cards attached to the package. The breakaway package can also be attached to or enclosed within a card carrier package.

### FIELD OF THE INVENTION

This invention relates to the field of stored value card packaging. In particular, this invention relates to a breakaway packaging that is created simultaneously with the stored value card, in which the packaging contains a magnetic stripe having both activation information and Universal Product Code information.

### BACKGROUND OF THE INVENTION

Stored value cards (also known as gift cards or pre-paid debit cards) are well known in the industry, as is the importance of allowing the activation of such cards at the point of sale. Without point of sale activation, a stored value account associated with a card would have to be activated before an end user purchases the card. Because each stored value card would then have economic value even before purchase, it would be imprudent to display unsold cards where they can be physically handled by consumers since the risk of theft would be too high. While the cards can be displayed in a locked cabinet, it is well known that this has a negative impact on card sales.

By moving toward point of sale activation, the cards have no value until purchased. Consequently, it is possible to display cards to the public without worrying about theft. Because cards that are attractively displayed to the public result in more stored value card sales, retailers make a concerted effort to present the cards in an attractive manner primarily through the development of attractive packaging for the stored value cards. This packaging has generally taken two forms: a card carrier packaging to which the stored value card is glued or otherwise attached, and an integrated, breakaway packaging.

The card carrier packaging is generally made out of a paper or cardboard type material, although any suitable flat material may be used. The card is generally glued directly to the card carrier packaging. Alternatively, the card carrier packaging can wrap around the card so as to hold the card within a cavity or opening formed by the packaging itself.

Breakaway packaging integrates the stored value card and the packaging into a single sheet of material. The card is separated from the packaging by a score line or other mechanism that makes it possible to break, tear, or otherwise separate the card from the remainder of the sheet that constitutes the packaging.

Several inventors have obtained patent protection on improvements to the packaging used for displaying stored value cards. For instance, U.S. Pat. No. 5,918,909 describes a card carrier package for a stored value card in which a magnetic stripe on the stored value card extends beyond the perimeter of the card packaging. This allows the card to be activated via information found on the magnetic stripe without removing the card from the card carrier packaging or otherwise altering or manipulating the packaging. U.S. Pat. No. 5,921,584 discloses a breakaway card package in which the card is integrally formed with the package itself. In U.S. Pat. No. 6,957,737, multiple stored value cards are stored within an enclosed space that is formed on the card carrier package. These cards are each associated with a separate, individual account. A code can be read from the package that is used to activate all of the cards that are found within the package's enclosed space. Similarly, U.S. Pat. No. 7,063,255 describes a card carrier package onto which the stored value card is glued. The card carrier package contains a magnetic stripe. This magnetic stripe is like that found on the stored value card, except while both stripes identify the same account number, the format of the two stripes is different. The stripe on the card carrier package can only be used to activate the account, while the card identifier is used only to access the account for purchases. Because the card carrier package and the card itself must both identify the same account, care must be taken to match the two components before the card is glued to the card carrier. Unfortunately, these and other prior art approaches to combining stored value cards and packaging for point of sale activation are lacking important features.

### SUMMARY OF THE INVENTION

The present invention combines breakaway packaging with one or more stored value card. Each of the stored value cards contains a card magnetic stripe while an end portion of the packaging contains a package magnetic stripe. The card magnetic stripes each contain an account identifier that identifies an account associated with the stored value card. This account identifier allows the card to be used to make a purchase transaction against a dollar value associated with that account in a stored value card account database.

The package magnetic stripe contains both a Universal Product Code (or “UPC”) associated with the breakaway package as well as account activation information. This activation information contains enough details about the accounts associated with the cards attached to the breakaway packages as to be able to identify those accounts.

In use, the package magnetic stripe is read once at a point of sale location. This single read determines the UPC for the purchase transaction, as well as the account information needed to activate the accounts.

The breakaway package can also be attached to or enclosed within a card carrier package. The card carrier package is preferably manufactured such that that the package magnetic stripe can be read by a reading device without removing the breakaway package from the card carrier package.

To manufacture the present invention, the breakaway package is constructed integral with one or more stored value cards, with the card stripes and package stripe ready to be encoded. In a single pass through an encoding device, all of the card stripes and the package stripe are encoded with the information described above. At this point, the breakaway package can be attached to a card carrier package.

### BRIEF DESCRIPTION OF THE DRAWINGS

FIG. 1 is a back plan view of a first embodiment of the present invention.

FIG. 2 is a front plan view of the first embodiment shown in FIG. 1.

FIG. 3 is a schematic drawing of the data encoded on a package magnetic stripe that forms part of the present invention.

FIG. 4 is a schematic drawing showing a second embodiment of the data encoded on the package magnetic stripe.

FIG. 5 is a schematic drawing showing a third embodiment of the data encoded on the package magnetic stripe.

FIG. 6 is a flow chart showing the method used to purchase and activate stored value cards using the present invention.

FIG. 7 is a schematic system diagram showing the primary elements of the system used to purchase and activate stored value cards using the present invention.

FIG. 8 is a back plan view of a second embodiment of the present invention.

FIG. 9 is a back plan view of a third embodiment of the present invention.

FIG. 10 is a back plan view of a fourth embodiment of the present invention.

FIG. 11 is a back plan view of a fifth embodiment of the present invention.

FIG. 12 is a back perspective view of the fifth embodiment of FIG. 11 with both the front and back flaps folded.

FIG. 13 is a back perspective view of the fifth embodiment of FIG. 11 with only the back flap folded.

FIG. 14 is a back perspective view of a sixth embodiment of the present invention with both the front and back flaps folded.

FIG. 15 is a schematic system diagram showing the primary elements of the system used to encode stored value cards and breakaway packaging.

FIG. 16 is a flow chart showing the method used to manufacture the present invention.

### DETAILED DESCRIPTION OF THE INVENTION

### Identification of the Problem

It is known in the prior art that multiple stored value cards can be activated in a single transaction. To accomplish this, an activation code was placed on the card carrier packaging that contained all of the cards. As described in U.S. Pat. No. 6,957,737, reading this single identification code activated all of the cards. However, previous methods of gathering these cards together required that the verification step be performed to ensure that the proper cards have been placed in the package. See U.S. Pat. No. 6,957,737, col. 4, lines 33-50. While this verification step can be automated, such as shown in U.S. Pat. No. 5,715,653, even the automated step requires a multi-step process for associating a single identification code with multiple stored value cards.

The inventor of the present invention has also identified a further inefficiency in the activation process. In most prior art activation processes, an employee at a point of sale terminal will ring up the sale of a stored value card using a standard UPC and then activate the stored value card by reading account information off of the card itself. Thus, two steps are required for every stored value card purchase: reading the UPC code for the purchase, and reading the account information for card activation.

One prior art system combined the UPC code and the account activation information into a bar code printed on the exterior of a product package. However, the printing of this information required a multiple step “match” printing process in which the card account information must be first read, combined with the UPC code, and printed as a hybrid number on a package. Once the card carrier package has been printed with this hybrid number, it must be matched with and then attached to the stored value card. A similar system is shown in U.S. Pat. No. 5,777,305.

### First Breakaway Packaging Embodiment

The present invention packaging for stored value cards addresses these limitations of the prior art. In the present invention, integrated or breakaway packaging is created with one or more stored value cards already attached. A magnetic stripe is then encoded on the breakaway packaging that contains both the Universal Product Code and account identifying information for the stored value card(s).

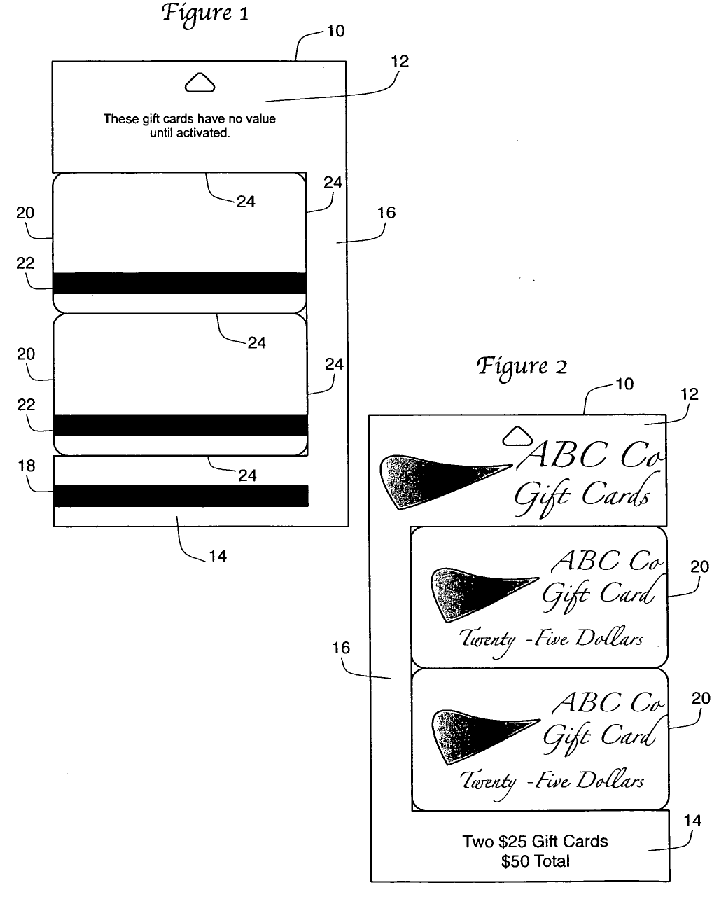

FIGS. 1 and 2 show the back and front of the present invention packaging 10, respectively. The packaging 10 is a C-shaped integrated or breakaway package, with a top portion 12, a bottom portion 14 and a side portion 16. The C-shaped package 10 surrounds two stored value cards 20. Each card 20 has attached to its rear surface a magnetic stripe 22, which contains account information that is employed when the card is used to make a purchase at a point of sale location. Similarly, the integrated package 10 has a magnetic stripe 18 that is used to activate the cards 20 attached to the package 10. The cards 20 can be easily separated from the package 20 because of the score lines 24 that had been put between the cards 20 and the package 20.

The front sides of the packaging 10 and cards 20 are shown on FIG. 2, and contain logos and verbiage that identifies the organization sponsoring the stored value card. In the example embodiment shown in FIG. 2, the bottom portion 14 also contains a legend indicating that this package 10 contains two $25 gift cards, and is sold for a total of $50.

### Data Description

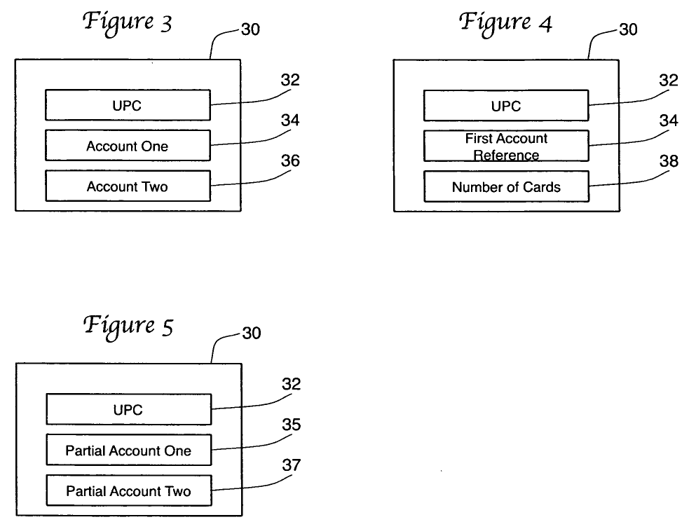

FIG. 3 shows the information 30 that is stored on the packaging magnetic stripe 18. This information includes the Universal Product Code 32 associated with the packaging 10, as well as account information for first account 34 and a second account 36. If more than two stored value cards are sold with the packaging, account information for each of the accounts associated with the stored value cards should be included in this information 30. Similarly, if only a single stored value card is being sold in this package, only the UPC information 32 and account information associated with the single account 34 is included in the information 30. In one embodiment, the account information shown as data 34 and 36 includes the entire account number. These are the same numbers that would be encoded in the card magnetic stripes 22 on the stored value cards 20.

Such information could also be stored in a short hand way. For instance, the separate account numbers associated with each stored value card could be defined sequentially. In this way only a single full account number 34 must be encoded in information 30, along with a count of the number of cards in the package. This structure of information 30 is shown in FIG. 4 with the number of cards shown as data element 38. In fact, the UPC code itself could be associated with a particular number of cards, such that data element 38 could be eliminated from the data 30 stored on packaging stripe 18.

Alternatively, as shown in FIG. 5, the account information associated with each stored value card 20 could be only part of the full account number. For instance, those portions of the account number that remain consistent throughout a company's or financial institution's account number range need not be duplicated in the information 30. In this circumstance, the UPC information 32 is still found in information 30. However, account one and account two are represented by partial account number information 35 and 37 respectively. Other variations of the actual account numbers are also possible. For instance, the account information in packaging stripe 18 may be a hash, or some other variation of the account number from which the account number can be derived.

### Method and System for Activation

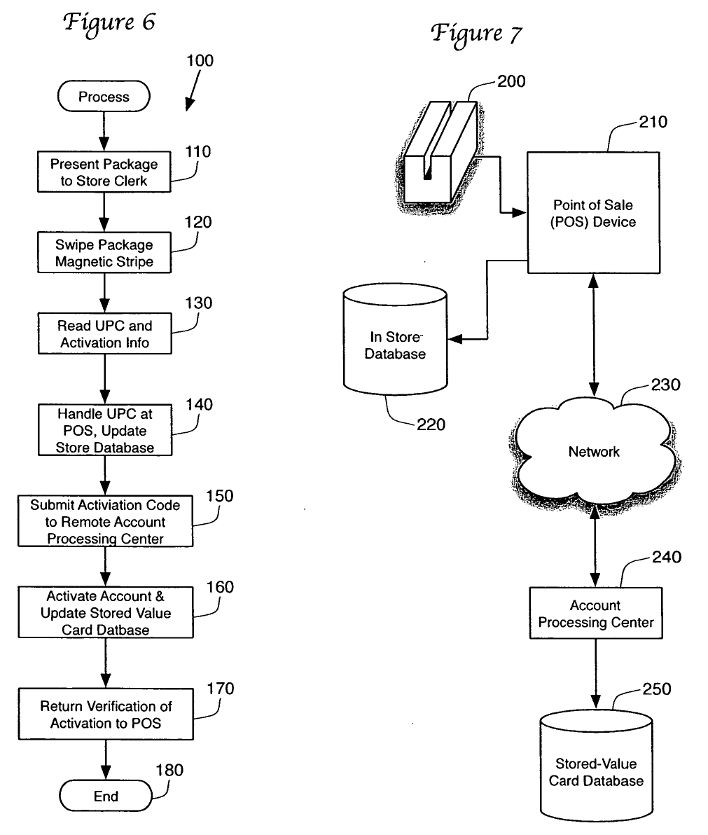

When a customer elects to purchase these gift cards 20, the packaging 10 is brought to a point of sale checkout location and presented to the store clerk for purchase. This is shown as step 110 in the flow chart 100 shown in FIG. 6. The store clerk will then swipe the package magnetic stripe 18 through a magnetic stripe reader 200. This reader 200 is shown in the system diagram found in FIG. 7. The swiping of the magnetic stripe 18 through reader 200 is step 120 in FIG. 6. The magnetic stripe reader 200 will read from the packaging magnetic stripe 18 both the Universal Product Code for the package as well as activation account information, as shown in step 130. The UPC is widely used to identify products that are purchased at a point of sale location in retail stores. The activation information includes the account numbers or other account identifying information for each of the cards 20 that are attached to the packaging 10.

The point of sale device 210 (which may be a general purpose computer or a dedicated point of sale terminal device) shown on FIG. 7 receives both the UPC code and the activation information from the magnetic stripe reader 200. The POS device 210 then handles the UPC code read from the packaging 10 just as it would for all other product purchases made at the POS device 210 (step 140). For example, the POS computer 210 may store sales transactions such as the purchase of the package 10 containing cards 20 in a store database 220.

In addition to handling the purchase using the UPC code, the point of sale device 210 will read the activation information and will submit a request to activate the accounts associated with cards 20 in step 150. This request will generally be submitted to a remote location over a network 230. The activation request will be received by an account-processing center 240. A computer at the account-processing center 240 will receive the activation information identifying the accounts associated with the cards 20 attached to package 10 and will begin processing the activation for those accounts. The activation of these accounts occurs at step 160 in method 100. In activating these accounts at the account-processing center 240, a stored-value accounts database 250 that contains information about the accounts will usually be updated to indicate that the accounts have been activated. Information regarding transactions made using the stored value cards 20 and the total dollar amount remaining in the associated accounts is also stored in the database 250. Once activation is complete, the account-processing center 240 will return a signal verifying success in the activation process back to the point of sale device 210 (step 170). At this point the process 100 ends at 180 with all of the cards 20 associated with packaging 10 having been activated.

### Alternative Embodiments

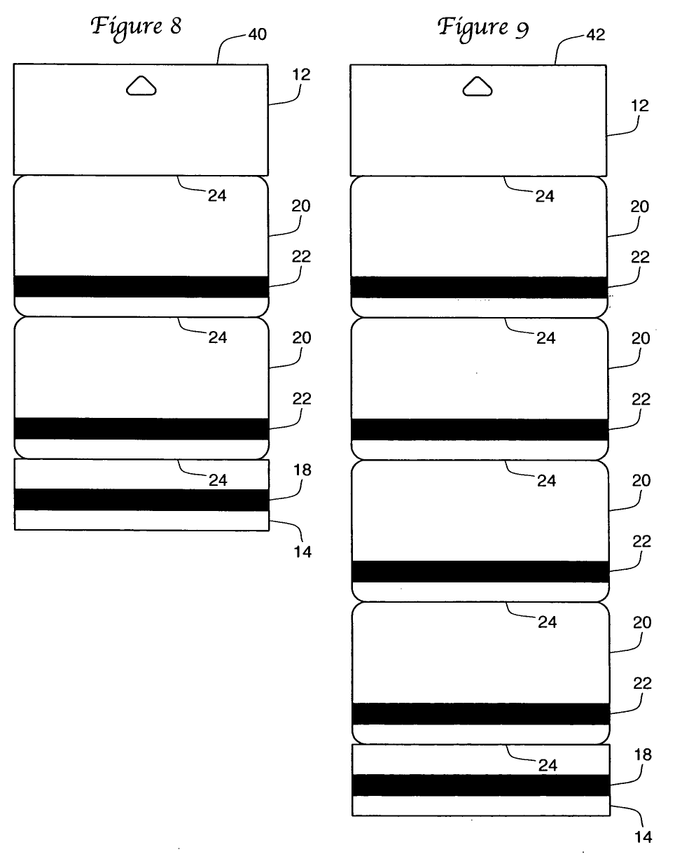

In FIGS. 1 and 2, the side portion 16 of the packaging 10 connects the top portion 12 and the bottom portion 14 of the package together. In FIG. 8, packaging 40 contains two stored value cards 20, a top portion 12, and a bottom portion 14, but no side portion 16. Instead, the bottom portion 14 simply breaks away completely from the cards 20 along one of the score lines 24. Using these score lines 24, the packaging 40 and cards 20 combination can be easily broken into four separate pieces. The packaging stripe 18 in package 40 contains information identifying the accounts associated with the two stored value cards 20 attached to the package 40. However, the bottom portion 14 cannot be used as a stored value card because the magnetic stripe 18 on bottom portion 14 is not consistent with the magnetic stripes 22 that are found in the cards 20.

FIG. 9 shows yet another packaging 42 for stored value cards 20. In this packaging 42 four different stored value cards 20 are attached to a top portion 12 and a bottom portion 14 of the packaging 42. Each of these components can be broken away from each other such that when completely dismantled, the packaging 42 includes the top portion 12 separated from the bottom portion 14, both of which are separated from the four individual cards 20. The packaging magnetic stripe 18 on package 40 includes information identifying the accounts associated with each of the four different stored value cards 20. For example, each account number found on the magnetic stripes 22 on each of the cards 20 could be found on the packaging magnetic stripe 18 along with the Universal Product Code for package 42. Alternatively, the cards 20 could be consecutively numbered with only a single number and an indicator as to the number of cards 20 in package 42 being found on magnetic stripe 18.

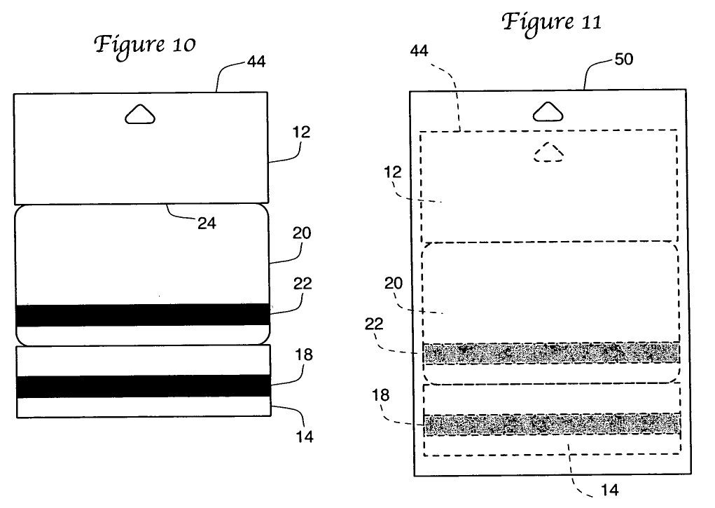

FIG. 10 shows yet another packaging 44 with an upper portion 12 and a bottom portion 14. In this package 44, only a single stored value card 20 is found between the upper portion 12 and the lower portion 14. Once again, the packaging magnetic stripe 18 includes both the universal package code and an indication of the account number associated with the single stored value card 20 found in the packaging 44.

### Card Carrier Packaging

In FIG. 11, the breakaway or integrated sheet packaging 44 is found within an external card carrier package 50. As explained above, card carrier packaging is packaging that is composed of printed paper or paperboard material (or another similar flat sheet) that is either glued to or encloses a stored value card. In FIG. 11, the card carrier package 50 glued around at least two edges so as to fully enclose the breakaway packaging 44 that includes a single stored value card 20. Encompassing packaging 50 can be printed so as to provide a pleasing display to attract customer attention.

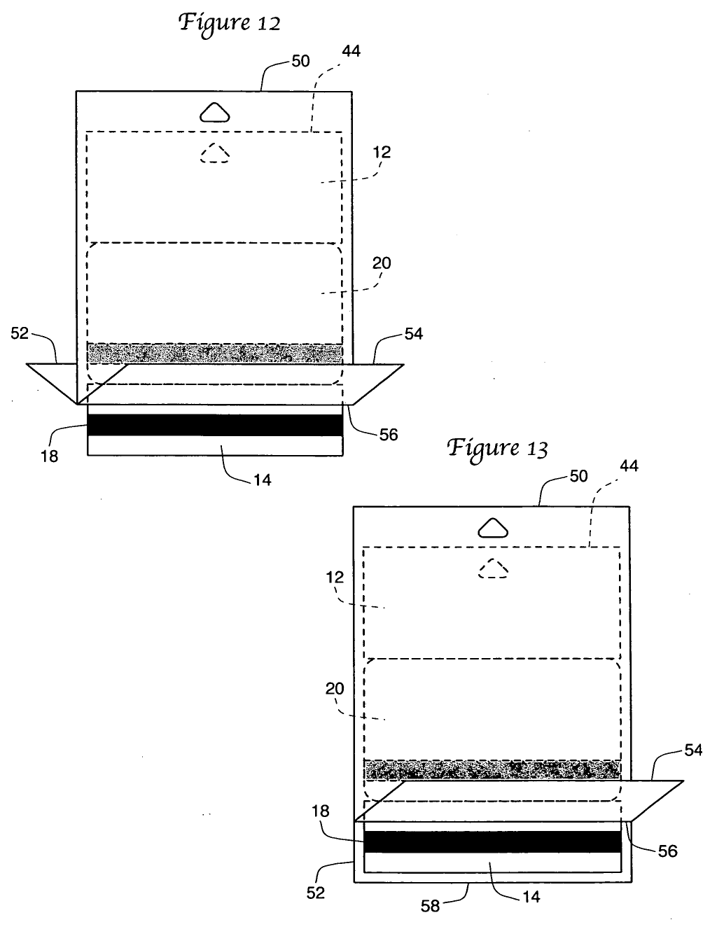

Preferably, the bottom of card carrier package 50 is not completely glued together and includes one or more fold away section 52, 54 as shown in FIGS. 12 and 13. Folding assist lines found at folding location 56 allow a store clerk to fold back sections 52 and 54 away from the bottom portion 14 of packaging 44, thereby exposing the packaging magnetic stripe 18. By folding away portion 52 and 54, the card carrier packaging 50 can remain surrounding the stored value card 20 and breakaway packaging 44 while still exposing the bottom portion 14 and the magnetic stripe 18.

In FIG. 13, only front portion 54 is folded away from the bottom portion 14 of packaging 44, thereby exposing the rear side of packaging 44 along with magnetic stripe 18. Portion 52 remains in contact with the front of bottom portion 14 of packaging 44.

The purpose of exposing the magnetic stripe 18 is to allow a clerk to pass this magnetic stripe 18 through a magnetic stripe reader 200. In FIG. 12, all of the card carrier packaging 50 near magnetic stripe 18 has been folded away in folded portion 52 and 54, thereby allowing the reading of the magnetic stripe 18 by any standard magnetic stripe reader 200. In FIG. 13, the fact that portion 52 remains unfolded adds an additional space between the bottom most point 58 of the encompassing packaging 50 and the magnetic stripe 18. Since this space is longer than the space between the bottom of the bottom portion 14 and the magnetic stripe 18, this method of reading the magnetic stripe 18 will work only with readers capable of reading the magnetic stripe 18 when the distance between the magnetic stripe and the bottom portion of the packaging 58 is slightly longer than normally expected.

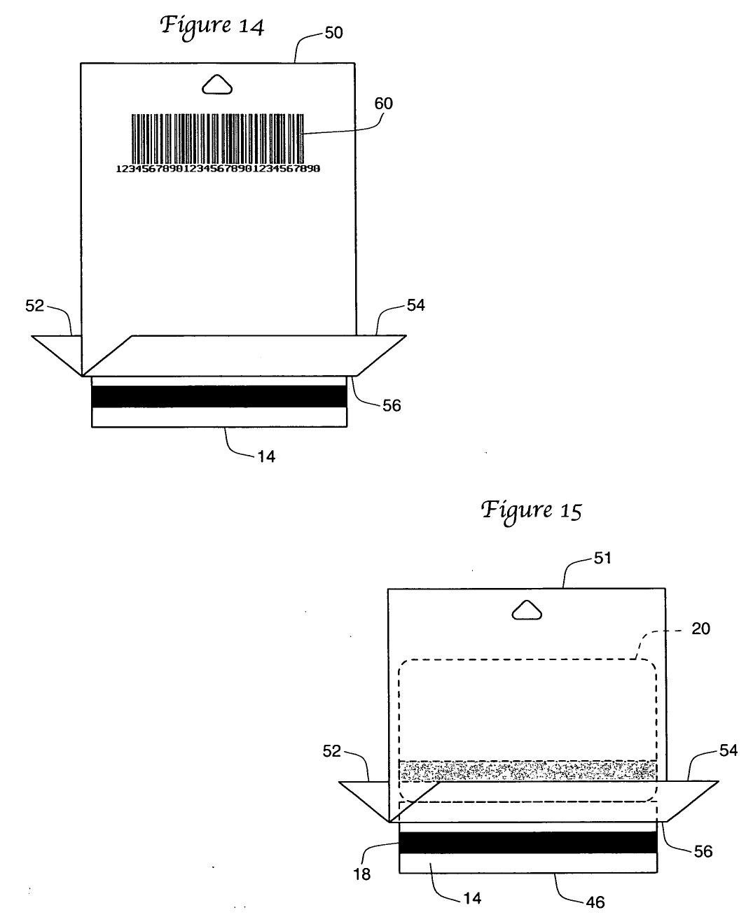

FIG. 14 shows the card carrier packaging 50 with folded portion 52 and 54 folded away from the bottom section 14 of breakaway packaging 44. In addition, FIG. 14 shows a bar code 60 printed on the external surface of the card carrier packaging 50. This bar code duplicates the information found in the packaging magnetic stripe 18, therefore it includes both the Universal Product Code information required for purchasing the product as well as the account information associated with the enclosed stored value card(s) 20. By providing both a bar code 70 and a magnetic stripe 18 containing the same information, the packaging 50 shown in FIG. 14 can be used by a variety of point of sale devices including those that are capable of reading only one of the bar code 70 or magnetic stripe 18.

FIG. 15 shows an alternative embodiment of the card carrier packaging 51. This packaging 51 still surrounds a breakaway package 46 with a stored value card 20, but this breakaway package 46 consists only of bottom portion 14 and does not contain either a top portion 12 or a side portion 16. The removal of the top portion 12 has no effect on the usefulness of the present invention since the top portion 12 of package 44 shown in FIGS. 11-14 has no utilitarian or decorative purpose.

FIGS. 11 through 15 show a card carrier packaging 50 that completely encompasses the breakaway packaging 44 and the stored value card 20. It would also be possible to have the breakaway packaging glued to one of the major sides of a single sheet of a card carrier packaging 50. Either way, the the breakaway packaging 44 (and cards 20) can be attached to the card carrier packaging 50 in such a way as to make it clear if the cards 20 were tampered with prior to activation. Tamper-evident methods for securing stored value cards to card carrier packaging are well known in the prior art. FIGS. 11 through 14 also show breakaway packaging 44 with only a single stored value card 20. It would be well within the scope of the present invention to combine the card carrier package 50 with breakaway packaging having more than one stored value card 20 (such as packages 10, 40, and 42).

### System and Method for Encoding

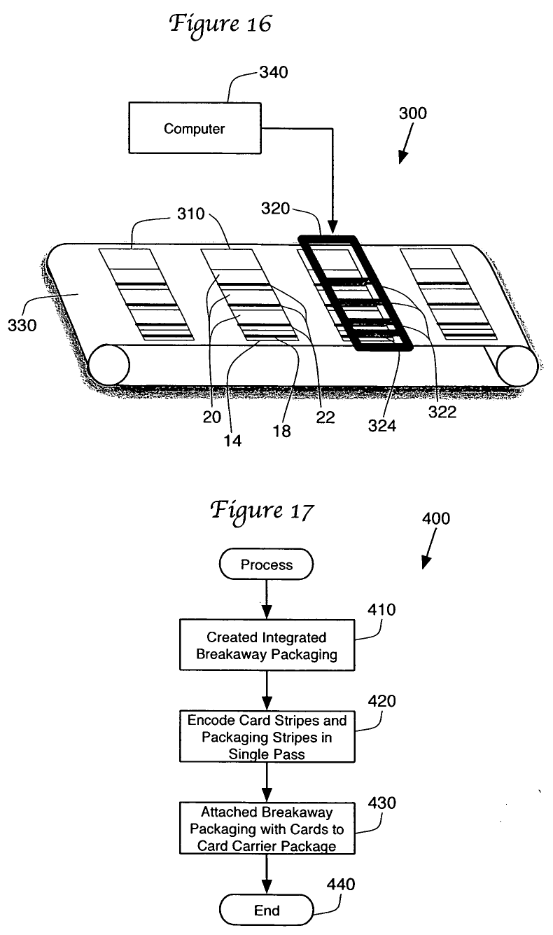

FIG. 16 shows a system 30 for encoding multiple breakaway packages 310, each of which contain one or more stored value cards 20. The packages 310 each have four magnetic stripes that must be encoded, namely three stored value card magnetic stripes 22 as well as a packaging magnetic stripe 18 found on bottom portion 14. The purpose of the system 300 is to move the packages 310 relative to an encoding device 320 that is capable of encoding all four magnetic strips 22, 18 in a single pass. In the embodiment shown in FIG. 16, the relative motion is provided by a conveyor system 330 that moves the packages 310 relative to the encoding device 320. Other techniques for ensuring that the packages 310 move relative to the encoding device 320 are contemplated within the scope of this invention and would be known to those of skill in the art. When a package 310 moves adjacent to the encoding device 320, card encoding mechanisms 322 on device 320 electronically encode account numbers on each of the stored value cards magnetic stripes 22. The account numbers are provided by a computer 340 that is in data communication with the encoding device 320. In addition to the stored value card encoding mechanism 322, the encoding device 320 includes a package encoding mechanism 324 for encoding the packaging magnetic stripe 18. This stripe 18 is encoded with the Universal Product Code assigned to this package 310 as well as information associated with each account identified with the stored value cards 20 on their package 310. This information is also provided by the computer 330.

The primary advantage of this technique for encoding both the package stripe 18 and the stored value card stripe 22 is that there is no need to use multiple passes of the packages 310 through the encoding device 320. Other prior techniques of encoding stored value card packages with information concerning account numbers of the attached cards required that the magnetic stripes 22 required multiple passes. The individual stored value cards 20 had to be read to ensure that the information encoded on the packaging was appropriate for the attached cards. In addition, as mentioned above, the encoding of the Universal Product Code on the packaging stripe 18 allows a single pass read at the point of sale, thereby eliminating at least one step from the process of purchasing one or more stored value cards 20.

The method for manufacturing the present invention is shown in FIG. 17. First, at step 410, the breakaway packaging 310 is created integral with one or more stored value cards 20. Each stored value card 20 has its own card magnetic stripe 22, while the bottom portion 14 of the breakaway packaging 310 has its own magnetic stripe 18. In step 420, the breakaway packaging 310 is passed near an encoding device 320. This device 320 encodes each card stripe 22 with account information for that card 20 while also encoding the packaging stripe 18 with the UPC code for the package 310 and account information sufficient to identify the accounts for all of the cards 20. At this point, the breakaway package 320 can be attached to a card carrier package 50 at step 430. Of course, this step 430 can be skipped leaving just the breakaway package 310 to serve as the packaging seen by the customer at the point of sale location.

The many features and advantages of the invention are apparent from the above description. Numerous modifications and variations will readily occur to those skilled in the art. For example, while card carrier stripe 18 is shown as part of the bottom portion 14 of the breakaway packaging 10, it would be well within the scope of the present invention to locate this stripe elsewhere on package 10. For instance, the stripe 18 may be located at the top portion 12, the side portion 16, or any end portion. In addition, the breakaway package describe above has formed integral to it an end portion which is separated from the stored value card by “score” lines 24. The phrase “score line” should not be limited to mean only those lines created by physically scoring a product (such as by a slight surface cut). Other techniques for keeping two portions together while allowing easy separation at a later time should be considered encompassed by the term “score line.” Since such modifications are possible, the invention is not to be limited to the exact construction and operation illustrated and described. Rather, the present invention should be limited only by the following claims.

What is claimed is:

1. A breakaway stored value card package comprising:
a) at least one stored value card having a card magnetic stripe,
b) an end portion of the package, the end portion and the stored value cards being formed from a single sheet of material and being divided by a score line, the end portion having a packaging magnetic stripe;
c) the card magnetic stripe containing identifying information for an account; and
d) the packaging magnetic stripe having:
i) a Universal Product Code for identifying the package at a point of sale location; and
ii) account identifying information for identifying the accounts for all of the stored value cards.

2. The package of claim 1, wherein the package has at least two stored value cards.

3. A method for purchasing and activating at least one stored value card comprising:
a) providing a stored value card package containing
i) the stored value cards, with each stored value card having a card magnetic stripe containing identifying information for an account, and
ii) a packaging magnetic stripe containing a UPC code and account identifying information for identifying the accounts for all of the stored value cards;
b) reading only the packaging magnetic stripe at a point of sale location to read both the UPC code and the account identifying information;
c) using the UPC code to update purchase transaction database so as to register the sale of the stored value card package; and
d) using the account identifying information to activate the accounts associated with the stored value cards.

4. The method of claim 3, wherein the stored value card package contains at least two stored value cards that are activated in step d).

5. A method for manufacturing a stored value card package comprising:
a) using a single sheet of material to form at least one stored value card and an end portion of the package, the at least one stored value card being separated from the end portion of the package by an unbroken score line;
b) locating a card magnetic stripe on each stored value card;
c) locating a package magnetic stripe on the end portion of the package; and
d) encoding all of the card magnetic stripes and the package magnetic stripe in an encoding machine in a single pass, each card magnetic stripe being encoded with an account identifying information for a single stored value card account, while the package magnetic stripe being encoded with a Universal Product Code for the stored value card package and account identifying information to identify all of the accounts identified in the card magnetic stripes.

6. The method of claim 5, wherein at least two stored value cards are formed in the single sheet of material.
